(19) United States
(12) Patent Application Publication
(10) Pub. No.: US 2018/0107997 A1
(43) Pub. Date: Apr. 19, 2018

(54) MANAGING SOFTWARE LICENSING COST INFORMATION

(71) Applicant: VMWARE, INC., Palo Alto, CA (US)

(72) Inventors: NIKHIL DHANKANI, Palo Alto, CA (US); DATTATHREYA SATHYAMURTHY, Bangalore (IN); PIYUSH BHARAT MASRANI, Bangalore (IN); AMARNATH PALAVALLI, Seattle, WA (US); HEMANTH KUMAR PANNEM, Palo Alto, CA (US)

(21) Appl. No.: 15/494,587

(22) Filed: Apr. 24, 2017

(30) Foreign Application Priority Data
Oct. 17, 2016 (IN) 201641035494

(51) Int. Cl. G06Q 20/12; H04L 9/14; G06F 21/10

(52) U.S. Cl. CPC G06Q 20/1235; H04L 9/14; G06F 21/105; G06F 2221/0753; H04L 2209/603; G06F 2221/0755; G06Q 2220/18

(57) ABSTRACT

Techniques for managing software licensing cost information are disclosed. In one embodiment, license data including licensing cost information associated with a product may be obtained. A license key for the product may be generated by encrypting the license data using an encryption key. The license key and a decryption key may be provided to a management tool associated with a client device. The management tool may be enabled to decrypt the license key using the decryption key to track the licensing cost information associated with the product.

### RELATED APPLICATIONS

Benefit is claimed under 35 U.S.C. 119(a)-(d) to Foreign Application Serial No. 201641035494 filed in India entitled “MANAGING SOFTWARE LICENSING COST INFORMATION”, on Oct. 17, 2016, by VMware, Inc., which is herein incorporated in its entirety by reference for all purposes.

### TECHNICAL FIELD

The present disclosure relates to software licenses, and more particularly to methods, techniques, and systems for managing software licensing cost information.

### BACKGROUND

Software, particularly commercial software, is typically distributed from one entity to another in accordance with a software license. The license may grant a user/enterprise of the software particular rights. One manner of controlling use of the software in accordance with the terms of a license is to employ a license key that, when appropriately coupled with the licensed software, enables installation, execution and/or other aspects. Enterprises may buy a lot of such software and associated licenses.

### BRIEF DESCRIPTION OF THE DRAWINGS

FIG. 1 depicts an example licensing system for generating license keys for consumption by software products/applications, according to an example embodiment;

FIG. 2 depicts an example block diagram of a client device including a management tool, according to an example embodiment;

FIGS. 3A and 3B depict example user interfaces associated with the management tool, according to an example embodiment;

FIG. 4 is an example scenario illustrating license key generation and consumption, according to an example embodiment;

FIG. 5 is an example flow diagram of a method for managing software licensing cost information, according to an example embodiment and

FIG. 6 is a block diagram of an example computing system for managing software licensing cost information, according to an example embodiment.

### DETAILED DESCRIPTION

Embodiments described herein provide enhanced computer-based and network-based method, technique, and system for tracking and managing software licensing cost information using license keys. A licensing system may authenticate access, to a software product through the use of a license key supplied by a vendor (e.g., product manufacturer) and input by a user. The license key may be typically input at installation of the software product or activation of the software product, but the same technique could apply to updates or upgrades to the software product. In this case, the licensing system may include a license key generator, which generates and issues the license keys, and applications, which consumes the license keys. For example, a user may input the license key into an application, which decodes the license data of a license key (i.e., the list of licensed features and the expiration time), and then verifies the authenticity of the license.

Enterprises may have a significant number of such software products and associated licenses. Tracking and maintaining expenses associated with the software products may be a tedious task. For example, an Excel sheet including different product versions, licenses, renewals and their expenses may be maintained to track and manage the expenses. However, maintenance of such Excel sheets may become cumbersome and usage of data in Excel sheets for other purposes may become complex. For example, expense details may need to be entered manually into the billing software/management tools, which may be prone to errors.

Examples described herein may provide enhanced methods, techniques, and systems for managing software licensing cost information using license keys. In one embodiment, license data including licensing cost information associated with a product may be obtained. Further, a license key may be generated for the product by encrypting; the license data including the licensing cost information using an encryption key (e.g., asymmetric key). The license key may be provided to an application in the client device which is licensed to activate the product. Further, a corresponding decryption key may be published such that any billing software/management tool associated with the client device can receive the license key (e.g., as input) and decrypt the license key using the decryption key to automatically track the licensing cost information associated with the product.

### System Overview and Examples of Operation

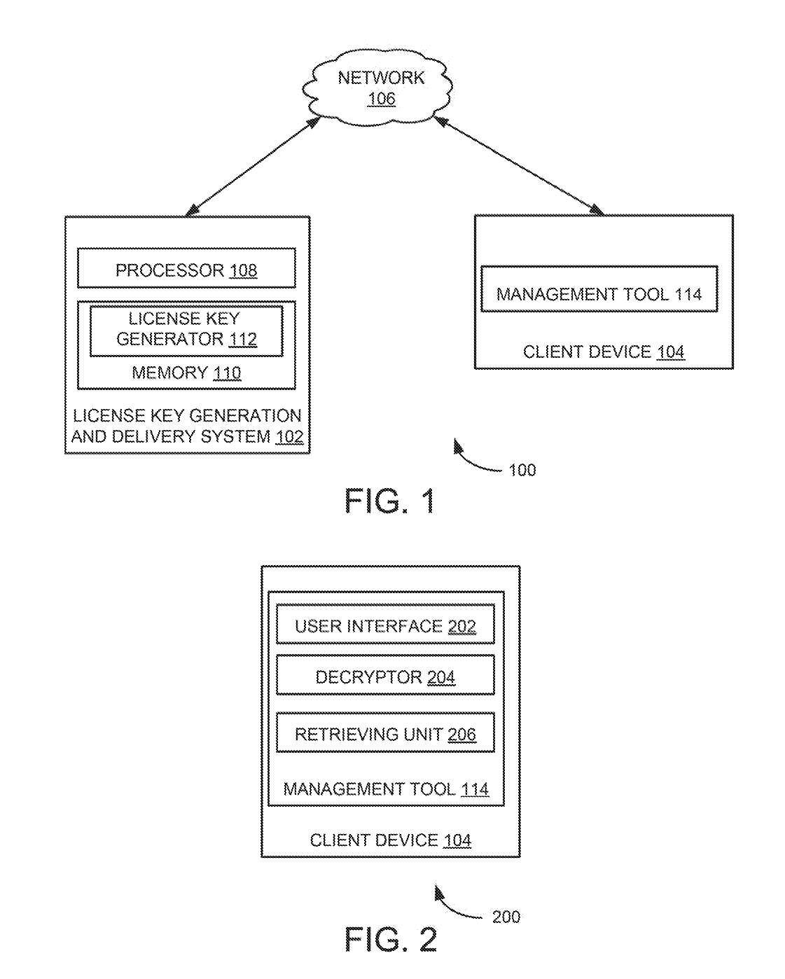

FIG. 1 depicts an example licensing system 100 for generating license keys for consumption by software products/applications, according to an example embodiment. As shown in FIG. 1, licensing system 100 may include a license key generation and delivery system 102 including a processor 108 and memory 110 coupled to processor 108. Memory 110 may include a license key generator 112. For example, license key generation and delivery system 102 may be associated with or part of a product manufacturer/vendor. For example, product manufacturer may manufacture products (e.g., software products) and may include assembly lines and raw materials inputs. The product may include any software application distributed from one entity to another in accordance with a software license. Example software application may include operating system (OS), security applications (e.g., antivirus, firewall, intrusion prevention and the like), VMware™ vCloud, and the like. Further, product manufacturer may generate data about the product. Example data may include seed data/license data selected from the group consisting of license type, allowed socket count (e.g., number of allowed processor sockets per server on which the product can run), virtual machine (VM) count, licensing cost, and expiry date. Example license type may include processor socket based per instance, per user, unlimited, etc. Processor socket based license may be defined based on number of central processing unit (CPU) sockets on the server running the software.

Further, licensing system 100 may include at least one client device 104. Client device 104 may be associated with a customer/user (e.g., enterprise) licensed to use the software product. Example client device 104 may include a user/client computer, server computer, smart phones, notebook computers, pocket computers, multi-touch devices, and/or any other devices with processing, communication, and input/output capability. Client device 104 may include a management tool 114. For example, management tool 114 may be an application (e.g., billing software or financial management tool) providing capabilities that allow users to gain greater visibility into financial aspects of their cloud infrastructure and to optimize and improve these operations. Further, management tool 114 may provide transparency and control over the costs and quality of IT services. An example of management tool 114 may include VMware® vRealize™ Business™ offered by VMware. In one example, management tool 114 may be implemented as engines or modules comprising any combination of hardware and programming to implement the functionalities described herein.

In one example, license key generation and delivery system 102 may generate and issue the license keys associated with the software products, and applications associated with client devices may consumes the license keys. Products may include new products, updates or upgrades to existing products. For example, a user types the license key into the application, which decodes the list of licensed features and the expiration time then verifies the authenticity of the license.

During operation, license key generator 112 may generate license keys for products made or produced, upon validation of a user's request. License key generator 112 may receive the license data including licensing cost information associated with a product. Further, license key generator 112 may generate the license key for the product by encrypting the license data using an encryption key. Using this technique, license key generator 112 can generate multiple license keys for multiple products using the same encryption key and the decryption key.

Furthermore, license key generator 112 may provide the license key and a decryption key to client device 104 of a user licensed to use the product. In one example, the license key and the decryption key are provided to client device 104 that is licensed to activate the product is a network 106. The license key may be used to activate licensed products associated with the user. For example, a user/enterprise, who wants to use the software product, may download a copy of the product to client device 104 via the network 106. To activate the product in the device, the user may send a request for a license key to the product manufacturer (e.g., license key generation and delivery system 102) via network 106. Upon validation of the request, the license key generated using the licensing cost information is sent to the client device 104, thereby activate the software application in client device 104.

Further, the decryption key may be published for use by client device 104 to verify the license key such that any software can decrypt the license key and interpret the meaning of the license using the license data. In this case, the decryption key can be published such that any billing software (e.g., management tool 114) associated with client device 104 receive the decryption key and use the decryption key to decrypt the license key to track the licensing cost information associated with the product. In one example, management tool 114 and the product can reside/run in same client device or different client devices.

In one example, the encryption key and the decryption key may be generated in conformance with asymmetric encryption techniques, in which the license key may include the license data signed by the encryption key and verifiable by the decryption key. Example encryption key may be a private key and the decryption key may be a public key. Even though examples described herein may use asymmetric encryption techniques (public/private key pair), other encryption techniques can also be used such that the encryption algorithm can generate the license key using the license cost information and the license key can be decrypted using a decryption algorithm associated with the licensee.

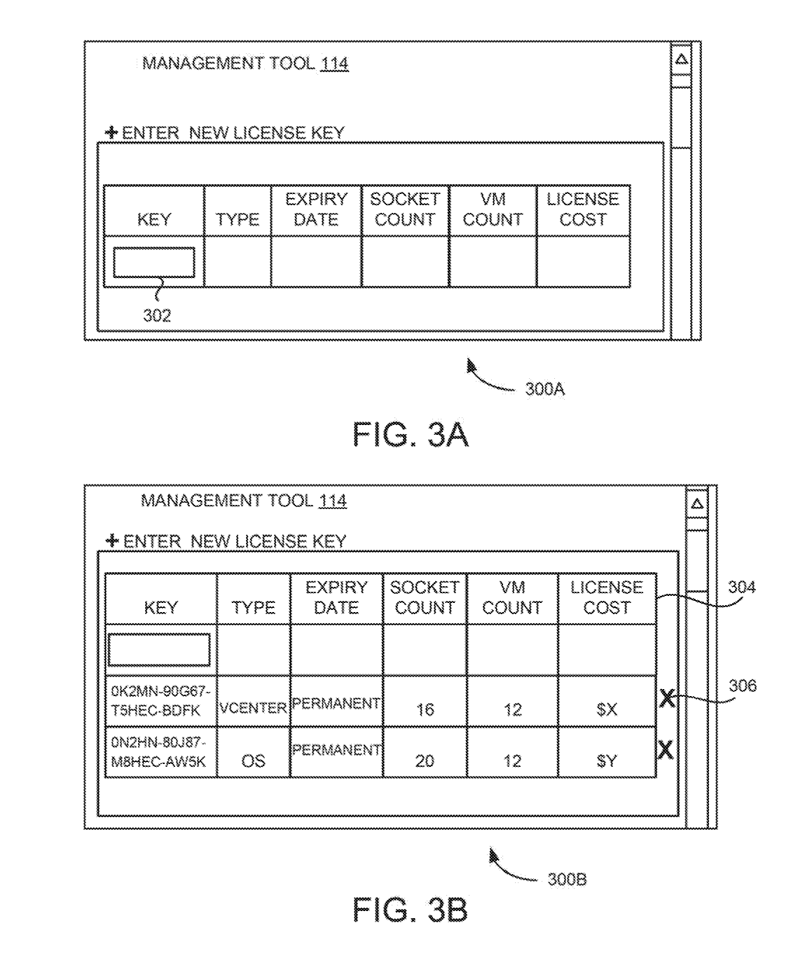

FIG. 2 is an example block diagram 200 of client device 104 including components of management tool 114, according to an example embodiment. Management tool 114 may include a user interface 202, decryptor 204 and retrieving unit 206. In one example, decryptor 204 may retrieve license data by decrypting the license key using the decryption key when the licensing key is inputted to management tool 114, for instance, via user interface 202. In another instance, the license keys may be retrieved is programmatic interface. Example user interface is explained in detail in FIGS. 3A and 38. Further, retrieving unit 206 may retrieve the licensing cost information associated with the product from the license data upon decrypting the license key. The retrieved licensing cost information can be used for total expense tracking, expense allocation, and charging to different business units and the like.

FIGS. 3A and 3B depict example user interfaces associated with the management tool 114, according to an example embodiment. Particularly, FIG. 3A depicts user interface 300A of management tool 114 providing an option 302 to input a license key associated with a product. When the license key is entered, management tool 114 may retrieve/obtain license data by decrypting the license key using the decryption key. An example of license data 304 retrieved upon decrypting the license key is shown in user interface 300B of FIG. 3B. Example license data may include license type, expiry date, socket count, VM count, and license cost as shown in FIG. 3B. Further, user interface 300B may depict an option 306 to delete any of the product information from the displayed information.

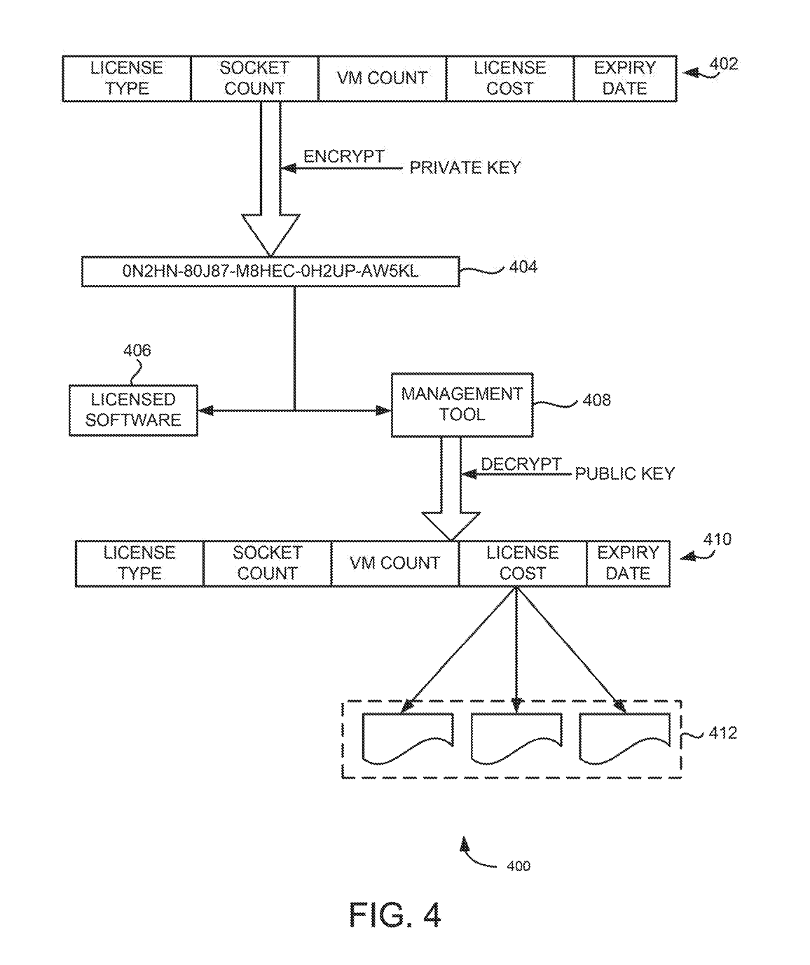

FIG. 4 is an example scenario 400 illustrating license key generation and consumption, according to an example embodiment. License data/bits 402 containing license information such as “License type”. “Allowed socket count”, “expiry date”, and the like associated with a product may be created, for instance, during manufacturing of a product. Product may refer to a new product, updates or upgrades to an existing product. Further, licensing cost information may be included into license data 402.

Further, an asymmetric key (e.g., public, private key pair) may be used to generate license key 404 using license data 402. In this case, the private key may be used to sign and encrypt license data 402 to generate license key 404. The public key may be published such that any software (e.g., management tools) can decrypt the license key and interpret the meaning of license using license data 402. In one example, license key 404 may be provided to licensee to activate licensed product/software 406. In another example, license key 404 may be inputted to management tool 408, for example, via a user interface. Management tool 408 may obtain/retrieve license data 410 by dectypting license key 404 using the published public key.

In one example, management tools may accept all license keys of different products associated with the enterprise, decrypt the license keys using the published public keys of the products, and maintain the licensing cost information. Vendors/manufacturers may have one private/public key pair for licensing thus creating multiple license keys for different products using the same private/public key pair. This may help management tools to easily interpret vendor's product license keys using a single public key. Once the licensing cost information is available in management tool, the licensed software user may use licensing cost information for different applications 412 such as, total expense tracking, expense allocation, and charging to different business units.

Licensing key generation and delivery system 102 may include computer-readable storage medium comprising (e.g., encoded with) Instructions executable by a processor to implement functionalities described herein in relation to FIG. 1. ln some examples, the functionalities described herein, in relation to instructions to implement functions of license key generator 112 and any additional instructions described herein in relation to the storage medium, may be implemented as engines or modules comprising any combination of hardware and programming to implement the functionalities of the modules or engines described herein. The functions of license key generator 112 may also be implemented by the processor. In examples described herein, the processor may include, for example, one processor or multiple processors included in a single device or distributed across multiple devices.

The embodiments described also can be practiced without some of the specific details described herein, or with other specific details, such as changes with respect to the ordering of the logic, different logic, different architectures, or the like. Thus, the scope of the techniques and/or functions described is not limited by the particular order, selection, or decomposition of aspects described with reference to any particular routine, module, component, or the like.

### Example Process

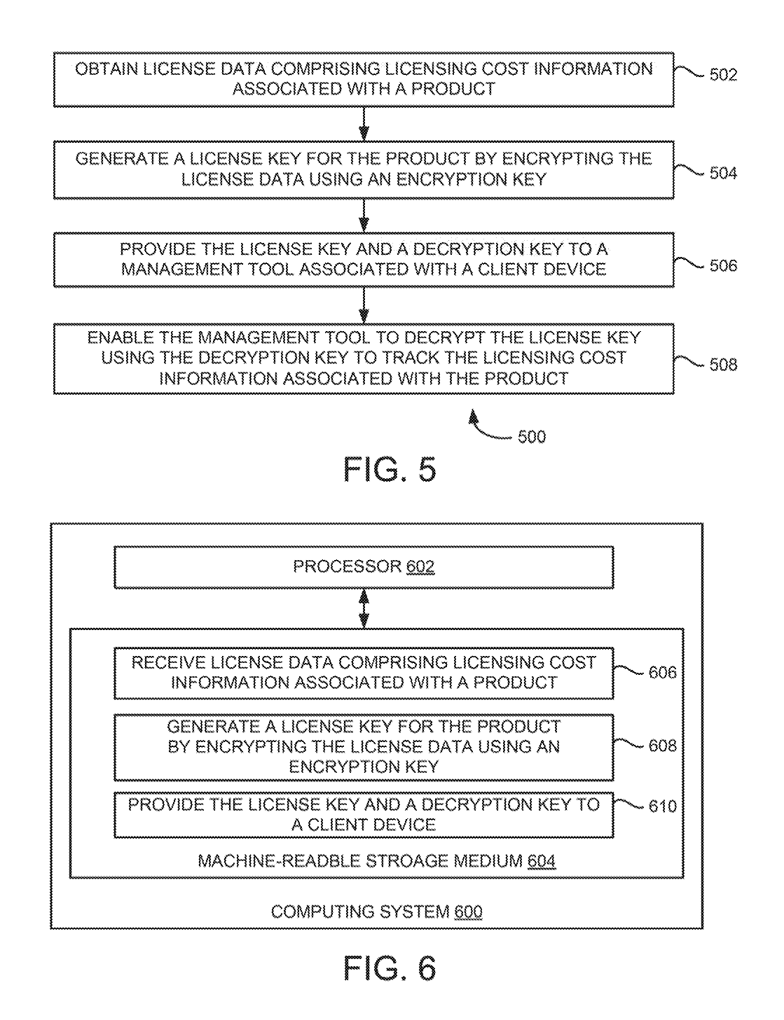

FIG. 5 is an example flow diagram 500 of a method for managing software licensing cost information, according to an example embodiment. It should be understood that the process depicted in FIG. 5 represents generalized illustrations, and that other processes may be added or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may re-present functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 502, license data including licensing cost information associated with a product may be obtained. The license data may include information that is used to authenticate license for the product. Example information may include, but not limited to, license type, allowed socket count, virtual machine count, licensing cost, expiry date, and the like. At 504, a license key may be generated for the product by encrypting the license data using an encryption key. At 506, the license key and a decryption key may be provided to a management tool associated with a client device.

In one example, the encryption key and the decryption key are generated in conformance with asymmetric encryption techniques, in which the license key may include the license data signed by the encryption key and verifiable by the decryption key. In another example, multiple license keys may be generated for multiple products using the same encryption key and the decryption key, with each license key corresponding to one product. The license key may be provided to at least one client device licensed to activate the product via a network. For example, the decryption key is provided by publishing the decryption key for use by the client device to verify the license key.

At 508, management tool may be enabled to decrypt the license key using the decryption key to track the licensing cost information associated with the product. In one example, the management tool may be enabled to retrieve the license data by decrypting the license key using the decryption key when the licensing key is inputted to the management tool. Further, the management tool may be enabled to retrieve the licensing cost information associated with the product from the license data upon decrypting the license key. The retrieved licensing cost information may be used for different applications such as, total expense tracking, expense allocation, and charging to different business units.

Although the flow diagram of FIG. 5 illustrates specific orders of execution, the order of execution can differ horn that which is illustrated. For example, the order of execution of the blocks can be scrambled relative to the order shown. Also, the blocks shown in succession can be executed concurrently or with partial concurrence. All such variations are within the scope of the present subject matter.

FIG. 6 illustrates a block diagram of an example computing system 600 for software licensing cost information, according to an example embodiment. Computing system 600 includes a processor 602 and a machine-readable storage medium 604 communicatively coupled through a system bus. Processor 602 may be any type of central processing unit (CPU), microprocessor, or processing logic that interprets and executes machine-readable instructions stored in machine-readable storage medium 604. Machine-readable storage medium 604 may be a random access memory (RAM) or another type of dynamic storage device that may store information and machine-readable instructions that may be executed by processor 602. For example, machine-readable storage medium 604 may be synchronous DRAM (SDRAM), double data rate (DDR) Rambus® DRAM (RDRAM), Rambus® RAM, etc., or storage memory media such as a floppy disk, a hard disk, a CD-ROM, a DVD, a pen drive, and the like. In an example, machine-readable storage medium 604 may be a non-transitory machine-readable medium. In an example, machine-readable storage medium 604 max be remote but accessible to computing system 600.

Machine-readable storage medium 604 may store instructions 606, 608, and 610. In an example, instructions 606-610 may be executed by processor 602 to generate and issue license keys to licensed users, which are used to manage licensing expense information associated with the products. Instructions 606 may be executed by processor 602 to receive license data comprising licensing cost information associated with a product. Instructions 608 may be executed by processor 602 to generate a license key for the product by encrypting the license data using an encryption key. Instructions 610 may be executed by processor 602 to provide the license key and a decryption key to a client device. In one example, the client device in a management application adapted to receive the license key and decrypt the license key using the decryption key to track the licensing cost information associated with the product.

Examples described herein may provide an open data model, in which metadata about application (e.g., public key and/or license data) published in a standard and simple way (Similar to QR code for Apps on mobile). Examples described herein may provide a secure way of generating the license key. For example, other applications (e.g., customer applications) can be able to read the data from the license keys, but cannot be able to generate the data, since private key is only available to vendors. Examples described herein may improve manageability of vendor's software by making license keys interpretable by other management tools. Management tools can be provided as a license expense management solution, which can be a competitive advantage over other show back/chargeback solutions.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or in an appropriate connection, such as a DVD or flash memory device) so as to enable or configure the computer-readable medium and/or one or more host computing systems or devices to execute or otherwise use or provide the contents to perform at least some of the described techniques. Some or all of the components and/or data structures may be stored on tangible, non-transitory storage mediums. Some or all of the system components and data structures may also be provided as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure ma be practiced with other computer system configurations.

It may be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A license key generation and delivery system, comprising:
a processor; and
memory coupled to the processor, wherein the memory comprises a license key generator to:
receive license data comprising licensing cost information associated with a product;
generate a license key for the product by encrypting the license data using an encryption key; and
provide the license key and a decryption key to a client device, wherein the client device comprises a management tool to decrypt the license key using the decryption key to track the licensing cost information associated with the product.

2. The license key generation and delivery system of claim 1, wherein the encryption key and the decryption key are generated in conformance with asymmetric encryption techniques, in which the license key comprises the license data signed by the encryption key and verifiable by the decryption key.

3. The license key generation and delivery system of claim 2, wherein the license key generator is to generate multiple license keys for multiple products using the same encryption key and the decryption key.

4. The license key generation and delivery system of claim 1, wherein the encryption key is a private key and the decryption key is a public key.

5. The license key generation and delivery system of claim 1, wherein the license key generator is to:
provide, via a network, the license key to at least one client device licensed to activate the product.

6. The license key generation and delivery system of claim 1, wherein the license data comprises information that is used to authenticate license for the product.

7. The license key generation and delivery system of claim 1, wherein providing the decryption key comprises publishing the decryption key for use by the client device to verify the license key.

8. The license key generation and delivery system of claim 1, wherein the management tool is to:
retrieve license data by decrypting the license key using the decryption key when the licensing key is inputted to the management tool; and
retrieve the licensing cost information associated with the product from the license data upon decrypting the license key.

9. A method for managing licensing cost information, comprising:
obtaining license data comprising licensing cost information associated with a product;
generating a license key for the product by encrypting the license data using an encryption key;
providing the license key and a decryption key to a management tool associated with a client device; and
enabling the management tool to decrypt the license key using the decryption key to track the licensing cost information associated with the product.

10. The method of claim 9, wherein the encryption key and the decryption key are generated in conformance with asymmetric encryption techniques, in which the license key comprises the license data signed by the encryption key and verifiable by the decryption key.

11. The method of claim 10, further comprising:
generate multiple license keys for multiple products using the same encryption key and the decryption key, wherein each license key corresponds to one product.

12. The method of claim 9, further comprising:
providing, via a network the license key to at least one client device licensed to activate the product.

13. The method of claim 9, wherein the license data comprises information that is used to authenticate license for the product.

14. The method of claim 9, wherein providing the decryption key comprises publishing the decryption key for use by the client device to verify the license key.

15. The method of claim 9, wherein enabling the management tool to decrypt the license key using the decryption key, comprises:
enabling the management tool to retrieve the license data by decrypting the license key using the decryption key when the licensing key is inputted to the management tool; and
enabling the management tool to retrieve the licensing cost information associated with the product from the license data upon decrypting the license key.

16. A non-transitory computer-readable storage medium including instructions that, when executed by a processor, cause the processor to:
receive license data comprising licensing cost information associated with a product;
generate a license key for the product by encrypting the license data using an encryption key;
provide the license key and a decryption key to a client device, wherein the client device comprises a management tool adapted to receive the license key and decrypt the license key using the decryption key to track the licensing cost information associated with the product.

17. The non-transitory computer-readable storage medium of claim 16, wherein the encryption key and the decryption key are generated in conformance with asymmetric encryption techniques, in which the license key comprises the license data sinned by the encryption key and verifiable by the decryption key.

18. The non-transitory computer-readable storage medium of claim 16, further comprising instructions, to:
provide, via a network, the license key to at least one client device licensed to activate the product.

19. The non-transitory computer-readable storage medium of claim 16, wherein the license data comprises information that is used to authenticate license for the product.

20. The non-transitory computer-readable storage medium of claim 16, wherein the management tool is to:
retrieve the license data by decrypting the license key using the decryption key when the licensing key is inputted to the management tool; and
retrieve the licensing cost information associated with the product from the license data upon decrypting the license key.
